(19) United States
(12) Patent Application Publication
(10) Pub. No.: US 2024/0283525 A1
(43) Pub. Date: Aug. 22, 2024

(54) RELAY APPARATUS

(71) Applicant: SUBARU CORPORATION, Tokyo (JP)

(72) Inventors: Masaaki HARADA, Tokyo (JP); Yuki SAKURAI, Tokyo (JP)

(21) Appl. No.: 18/416,127

(22) Filed: Jan. 18, 2024

(30) Foreign Application Priority Data
Feb. 22, 2023 (JP) 2023-026122

(51) Int. Cl. H04B 7/15; H04W 4/40

(52) U.S. Cl. CPC H04B 7/15; H04W 4/40

(57) ABSTRACT

A relay apparatus is to be applied to a vehicle. The relay apparatus is configured to relay a communication between an external device provided outside the vehicle and an electronic control unit mounted on the vehicle. The relay apparatus includes an external communication connector and a communication processor. The external communication connector is configured to communicably couple the external device. The communication processor is configured to control the communication between the external device coupled to the external communication connector and the electronic control unit. The communication processor is configured to block the communication between the external device and the electronic control unit after an ignition of the vehicle makes a transition to an off state.

### CROSS-REFERENCE TO RELATED APPLICATIONS

The present application claims priority from Japanese Patent Application No. 2023-026122 filed on Feb. 22, 2023, the entire contents of which are hereby incorporated by reference.

### BACKGROUND

The disclosure relates to a relay apparatus.

A vehicle control system mounted on a vehicle is provided with devices including electronic control units (ECUs) and a relay apparatus. The relay apparatus relays a communication between the ECUs and a communication with a device provided outside of the vehicle. The devices including the ECUs and the relay apparatus are communicably coupled to each other via an in-vehicle network. Each of the ECUs of the vehicle control system controls electronic devices and sensors that are necessary for traveling of the vehicle, while exchanging various types of data directly or via the relay apparatus.

The ECU is provided with an in-vehicle malfunction diagnostic device, e.g., an on-board diagnostics (OBD), allowing a malfunction code, e.g., a diagnostic trouble code (DTC), to be automatically recorded as malfunction data when, for example, a malfunction occurs in an electronic device or a sensor to be controlled. It is possible to read data including a detection value of the electronic device or the sensor and the malfunction code recorded in the ECU by coupling an external diagnostic device, e.g., a scan tool, to an external communication connector, e.g., an OBD port, adapted for the in-vehicle malfunction diagnostic device and provided on the relay apparatus.

When the relay apparatus receives a communication request from the scan tool coupled to the OBD port, the relay apparatus relays the communication request to the ECU belonging to a communication request destination. Thus, the relay apparatus maintains the ECU in a normal operation state, e.g., a wake-up state, to allow the ECU to make a response without causing the ECU to make a transition to a power saving state, e.g., a sleep state, thereby allowing the EUC to transmit the data described above to the scan tool.

Japanese Patent No. 5949538 discloses an example of the relay apparatus. The disclosed relay apparatus determines a state of a diagnosis device coupled to the relay apparatus via an external device connection connector, and causes an ECU to make a transition to a state in which a communication is executable when the relay apparatus determines that the diagnosis device is normal. The relay apparatus prevents the ECU from making the transition to the state in which the communication is executable when the relay apparatus determines that the diagnosis device is abnormal.

### SUMMARY

An aspect of the disclosure provides a relay apparatus to be applied to a vehicle. The relay apparatus is configured to relay a communication between an external device provided outside the vehicle and an electronic control unit mounted on the vehicle. The relay apparatus includes an external communication connector and a communication processor. The external communication connector is configured to communicably couple the external device. The communication processor is configured to control the communication between the external device coupled to the external communication connector and the electronic control unit. The communication processor is configured to block the communication between the external device and the electronic control unit after an ignition of the vehicle makes a transition to an off state.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a diagram illustrating a schematic configuration of a vehicle control system that includes a relay apparatus according to one example embodiment of the disclosure.

FIG. 2 is a flowchart illustrating an operation of the relay apparatus illustrated in FIG. 1.

### DETAILED DESCRIPTION

An external device made by a third party that is not intended to diagnose a malfunction may sometimes be coupled to an OBD port by a user. For example, an external device such as a radar finder or a drive recorder that is not intended, by a manufacturer of a vehicle, to be coupled to the OBD port may sometimes be coupled to the OBD port by the user. Some of such external devices continuously make a communication request to the vehicle while the external devices are coupled to the OBD port even when the external devices operate normally. In this case, each ECU is constantly maintained in a normal operation state in order to respond to the communication request made by the external device even when an ignition of the vehicle is in an off state, which can result in unnecessary consumption of electric power of the vehicle.

It is desirable to provide a relay apparatus that makes it possible to reduce power consumption of a vehicle.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

In the following description, the same reference numerals in different drawings denote components having the same function, and redundant descriptions of the respective drawings will be omitted as appropriate.

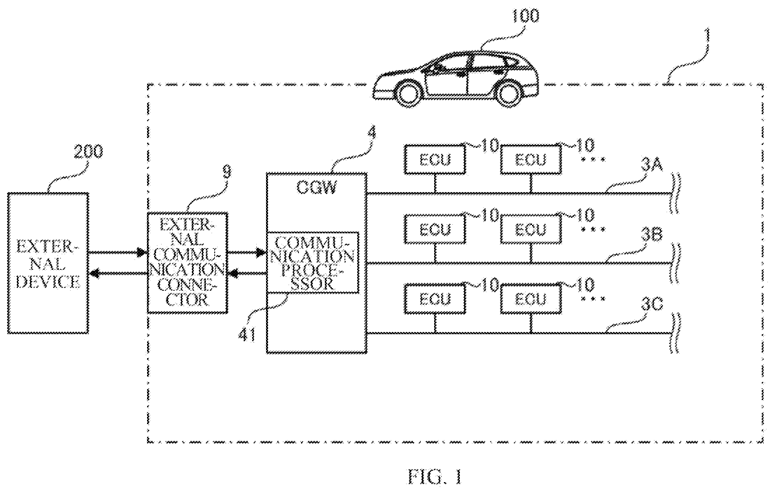

FIG. 1 illustrates a schematic configuration of a vehicle control system 1 to which a relay apparatus according to an example embodiment of the disclosure is applied. Referring to FIG. 1, the vehicle control system 1 may include: unillustrated various electronic devices necessary for traveling of a vehicle 100; electronic control units (ECUs) 10 that control the electronic devices; and a central gateway (CGW) 4 that relays a communication between the ECUs 10 and a communication between an external device 200 of the vehicle 100 and the ECUs 10. In one embodiment, the central gateway 4 may serve as a “relay apparatus”.

In the vehicle control system 1, the CGW 4, the ECUs 10, and the electronic devices to be controlled by the ECUs 10 may be communicably coupled to each other by bus lines 3A, 3B, and 3C to configure an in-vehicle network. The electronic device to be controlled by the ECUs 10 may be hereinafter referred to as a control target device. The bus lines 3A, 3B, and 3C may be any network such as a controller area network (CAN) or a local interconnect network.

The ECUs 10 each may be coupled to the control target devices, and each output data on an operation of the control target devices acquired from the control target devices to the bus lines 3A, 3B, and 3C. The ECUs 10 each may acquire data from, for example, another ECU 10 via corresponding one of the bus lines 3A, 3B, and 3C, and control operations of the respective control target devices based on the acquired data.

The ECUs 10 each may be operated by electric power supplied from an unillustrated battery. The ECUs 10 each may be switched, as appropriate, between a normal operation state, e.g., a wake-up state, in which the ECU 10 operates the control target devices and a power saving state, e.g., a sleep state, in which the ECU 10 does not operate the control target devices. The ECUs 10 each may be supplied, from the battery, with the electric power necessary to operate each of the control target devices in the normal operation state, and may be so suppressed that the electric power supplied from the battery is reduced or minimized in the power saving state.

The ECUs 10 may be classified, based on a functionality of the control target devices, into any one of: a power-train-based ECU that controls devices including, for example, an engine and a transmission; a chassis-based ECU that controls devices including, for example, a suspension and a steering; and a body-based ECU that controls devices including, for example, an air conditioner and a door. The ECUs 10 each may be coupled to corresponding one of the bus lines 3A, 3B, and 3C, based on functionality systems to which the respective ECUs 10 belong.

The power-train-based ECU 10 that controls the devices including, for example, the engine and the transmission may be coupled to the CGW 4 via the bus line 3A. The chassis-based ECU10 10 that controls the devices including, for example, the suspension and the steering may be coupled to the CGW 4 via the bus line 3B. The body-based ECU 10 that controls the devices including, for example, the air conditioner and the door may be coupled to the CGW 4 via the bus line 3C. In the following description, the bus lines 3A, 3B, and 3C may be simply referred to as a bus line 3 when referring to all of the bus lines 3A, 3B, and 3C.

The CGW 4 may include an external communication connector 9 adapted to communicably couple the external device 200, and a communication processor 41 that controls a communication between the external communication connector 9 and the ECUs 10. A scan tool adapted for an in-vehicle malfunction diagnostic device, e.g., an on-board diagnostics (OBD), and various external devices 200 may be coupled to the external communication connector 9 from the outside of the vehicle 100. The CGW 4 may be supplied with the electric power from the battery, by which the CGW 4 is able to operate regardless of a state of ignition of the vehicle 100 and to receive a communication request made by the external device 200 even when the state of ignition of the vehicle 100 is in the off state.

One of more of the CGW 4 and the respective ECUs 10 may include, for example: a processor such as a central processing unit (CPU) or a micro processing unit (MPU); electric circuitry; and storage devices including, for example, a random-access memory (RAM) and a read-only memory. All or a part of operations to be executed by one or more of the CGW 4 and the ECUs 10 may be achieved by hardware such as an application specific integrated circuit (ASIC), a field-programmable gate array (FPGA), or a graphics processing unit (GPU).

The processor such as the CPU of the CGW 4 may read a program stored in the ROM into a memory such as the RAM and execute the program, thereby serving as the communication processor 41. The communication processor 41 may control the communication between the external device 200 and the ECU 10 that belongs to a communication request destination, when the external device 200 is coupled to the external communication connector 9 and the communication request is transmitted from the external device 200 to the CGW 4.

The communication processor 41 may transmit or relay the communication request made by the external device 200 to the ECU 10 that belongs the communication request destination and maintain the ECU 10 in the normal operation state, e.g., the wake-up state, without causing the ECU 10 to make a transition to the power saving state, e.g., the sleep state, when allowing the external device 200 and the ECU 10 that belongs to the communication request destination to communicate with each other. For example, the communication processor 41 may transmit or relay data on the communication request made by the external device 200 to the ECU 10, and receive data corresponding to the communication request made by the external device 200 from the ECU 10 to transmit or relay the data to the external device 200.

The communication processor 41 blocks the communication between the external device 200 and the ECU 10 after the ignition of the vehicle 100 makes a transition to the off state, even when the communication processor 41 receives the communication request from the external device 200.

For example, the communication processor 41 may block the communication between the external device 200 and the ECU 10 as follows. In some embodiments, the communication processor 41 may block the communication between the external device 200 and the ECU 10 by making a rejection response to the communication request made by the external device 200. In some embodiments, the communication processor 41 may block the communication between the external device 200 and the ECU 10 by refraining from transmitting or relaying, to the ECU 10, the communication request in response to the communication request made by the external device 200.

In some embodiments, when the communication processor 41 receives the communication request from the external device 200, the communication processor 41 may block the communication between the external device 200 and the ECU 10 after a predetermined time elapses from the transition of the ignition of the vehicle 100 to the off state.

In some embodiments, the communication processor 41 may refrain from blocking the communication between the external device 200 and the ECU 10 when the vehicle 100 is in a predetermined state. Non-limiting examples of the predetermined state may include: a fuse state such as a state prior to shipment of the vehicle 100; and a specific security state such as a state in which the CGW 4 is set to a mode that accepts an operation to be performed by a user authorized in advance.

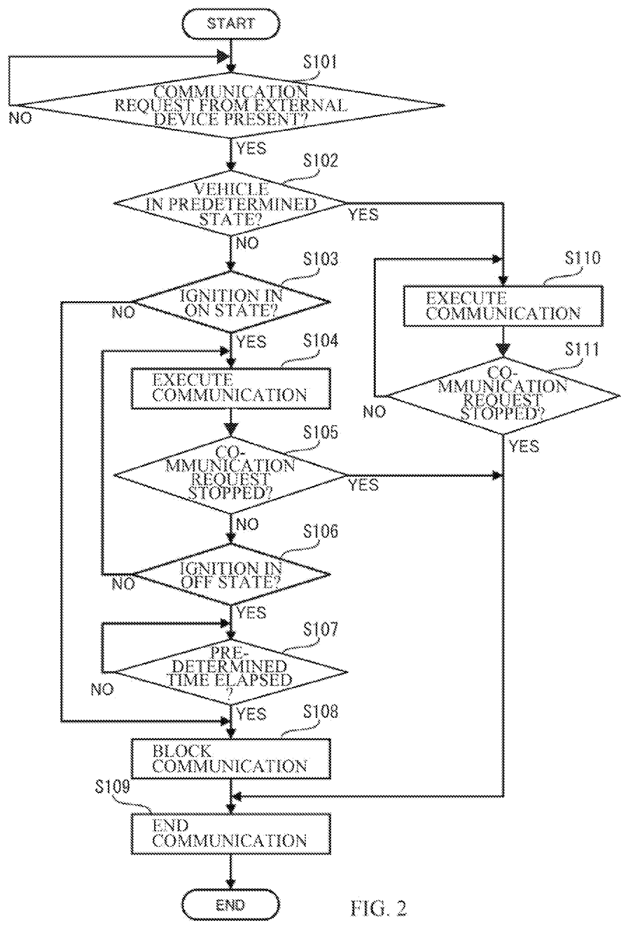

An example operation of the CGW 4 of the vehicle control system 1 configured as described above will be described below with reference to a flow chart illustrated in FIG. 2.

If the communication request is not transmitted from the external device 200 to the CGW 4 when the external device 200 is coupled to the external communication connector 9 (NO in step S101), a process of the step S101 may be repeated until the communication request is transmitted. If the communication request is transmitted from the external device 200 to the CGW 4 when the external device 200 is coupled to the external communication connector 9 (YES in step S101) and if the vehicle 100 is not in the predetermined state (NO in step S102), the CGW 4 may determine whether the ignition of the vehicle 100 is in an on state (step S103).

If the ignition of the vehicle 100 is in the off state (NO in step S103), the communication processor 41 of the CGW 4 may block the communication between the external device 200 and the ECU 10 (step S108). If the ignition of the vehicle 100 is in the on state (YES in step S103), the communication processor 41 may execute the communication between the external device 200 and the ECU 10 belonging to the communication request destination, and may transmit and receive any necessary data between the external device 200 and the ECU 10 (step S104). For example, the communication processor 41 may transmit the communication request received by the CGW 4 from the external device 200 to the ECU 10, receive data that is based on the request transmitted from the ECU 10 in response to the transmission of the communication request, and transmit the data received by the CGW 4 to the external device 200.

During the transmission and the reception, the CGW 4 may monitor the presence of the communication request made by the external device 200 and monitor a state of the ignition of the vehicle 100 (step S105 and step S106). When the communication request made by the external device 200 is stopped (YES in step S105), the communication processor 41 may end the communication between the external device 200 and the ECU 10 (step S109).

If the ignition of the vehicle 100 is in the on state (NO in step S106) in a state where the communication request from the external device 200 is not stopped (NO in step S105), the process may return to step S104. If the ignition of the vehicle 100 makes the transition to the off state (YES in step S106) in the state where the communication request from the external device 200 is not stopped (NO in step S105), the communication processor 41 may block the communication between the external device 200 and the ECU 10 (step S108) after a predetermined time elapses (YES in step S107).

If the vehicle 100 is in the predetermined state (YES in step S102) in the process of step S102, the communication between the external device 200 and the ECU 10 belonging to the communication request destination may be executed regardless of whether the ignition of the vehicle 100 is in the on state or the off state, and the transmission and the reception of the necessary data may be executed between the external device 200 and the ECU 10 (step S110).

During the transmission and the reception, the CGW 4 may monitor the presence of the communication request made by the external device 200. If the communication request is not stopped (NO in step S111), the CGW 4 may repeat the processes of step S110 and the step S111 until the communication request is stopped. If the communication request made by the external device 200 is stopped (YES in step S111), the communication between the external device 200 and the ECU 10 may be ended (step S109). After the communication between the external device 200 and the ECU 10 ends, the ECU 10 may make the transition to the power saving mode.

The relay apparatus according to the example embodiment described above relays the communication request made by the external device 200 to the ECU 10 when the ignition of the vehicle 100 is in the on state, and maintains the ECU 10 in the normal operation state to allow the external device 200 and the ECU 10 to communicate with each other. After the ignition of the vehicle 100 makes the transition to the off state, the relay apparatus blocks the communication between the external device 200 and the ECU 10 to prevent the ECU 10 from responding to the communication request made by the external device 200.

The ECU 10 may make the transition to the power saving state when the communication between the external device 200 and the ECU 10 is blocked and the communication is ended in the state where the ignition of the vehicle 100 is in the off state. This configuration helps to prevent the ECU 10 from being in the normal operation state in a situation where the communication between the external device 200 and the ECU 10 is not necessary, and to reduce power consumption of the vehicle 100.

Although some example embodiments of the disclosure have been described in the foregoing by way of example with reference to the accompanying drawings, the disclosure is by no means limited to the example embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof. Further, techniques according to the example embodiments and their modification examples described above may be combined in any combination unless any particular contradiction or issue occurs in terms of a purpose, a configuration, etc., thereof.

The communication processor 41 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the communication processor 41. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the communication processor 41 illustrated in FIG. 1.

1. A relay apparatus to be applied to a vehicle, the relay apparatus being configured to relay a communication between an external device provided outside the vehicle and an electronic control unit mounted on the vehicle, the relay apparatus comprising:
an external communication connector configured to communicably couple the external device; and
a communication processor configured to control the communication between the external device coupled to the external communication connector and the electronic control unit, the communication processor being configured to block the communication between the external device and the electronic control unit after an ignition of the vehicle makes a transition to an off state.

2. The relay apparatus according to claim 1, wherein the communication processor is configured to block the communication between the external device and the electronic control unit after a predetermined time elapses from the transition of the ignition of the vehicle to the off state.

3. The relay apparatus according to claim 1, wherein the communication processor is configured to block the communication between the external device and the electronic control unit by refraining from relaying, to the electronic control unit, a communication request made by the external device in response to the communication request made by the external device.

4. The relay apparatus according to claim 2, wherein the communication processor is configured to block the communication between the external device and the electronic control unit by refraining from relaying, to the electronic control unit, a communication request made by the external device in response to the communication request made by the external device.

5. The relay apparatus according to claim 1, wherein the communication processor is configured to block the communication between the external device and the electronic control unit by making a rejection response to a communication request made by the external device.

6. The relay apparatus according to claim 2, wherein the communication processor is configured to block the communication between the external device and the electronic control unit by making a rejection response to a communication request made by the external device.

7. The relay apparatus according to claim 1, wherein the communication processor is configured to refrain from blocking the communication between the external device and the electronic control unit when the vehicle is in a predetermined state.

8. The relay apparatus according to claim 2, wherein the communication processor is configured to refrain from blocking the communication between the external device and the electronic control unit when the vehicle is in a predetermined state.
